(19) United States
(12) Patent Application Publication
(10) Pub. No.: US 2007/0015548 A1
(43) Pub. Date: Jan. 18, 2007

(54) Vehicle tracker using common telephone number and unique identification number and associated methods

(75) Inventor: Kenneth E. Flick, Douglasville, GA (US)

Correspondence Address: CHRISTOPHER F. REGAN, ESQUIRE;ALLEN, DYER, DOPPELT, MILBRATH & GILCHRIST, P.A., P.O. Box 3791, Orlando, FL, 32802-3791, US

(73) Assignee: Omega Patents, L.L.C., Douglasville, GA (US)

(21) Appl. No.: 11/183,223

(22) Filed: Jul. 12, 2005

(51) Int. Cl. H04M 1/00

(52) U.S. Cl. 455/569.2; 455/456.1

(57) ABSTRACT

A vehicle tracker may include a cellular transceiver at a vehicle for receiving an activation message from a cellular communications network. The activation message may include a common telephone number for a plurality of vehicle trackers and a unique identification number for the vehicle tracker. A vehicle position-determining device may be at the vehicle. A controller at the vehicle may cooperate with the cellular transceiver and the vehicle position-determining device to transmit vehicle location data if the unique identification number in the received activation message matches the unique identification number for the vehicle tracker. The vehicle tracker may be part of a vehicle tracking system in which a plurality of vehicles may each have a respective vehicle tracker. The vehicle tracking system may include a user operable device to generate the activation message.

### FIELD OF THE INVENTION

The invention relates to the field of vehicle devices, and, more particularly, to vehicle security devices and related methods.

### BACKGROUND OF THE INVENTION

Car dealerships, fleet vehicle operators, and the like may have sizable investments in vehicle inventories that are very mobile. As a result, many of these businesses obtain security and/or monitoring of their vehicles. For example, a car dealership may obtain a security and tracking service cooperating with a vehicle security system at the vehicle that will alert the car dealer that a vehicle has been improperly accessed or removed from the car lot, as well as provide current vehicle location information.

U.S. Pat. No. 5,898,391 to Jefferies et al. discloses a vehicle security and tracking system that is remotely activated to provide a vehicle owner with current vehicle location information. The remote activation is provided by a user interface communicating via a paging system with a two-way pager transceiver at the vehicle. In response to the activation, the security and tracking system sends current vehicle location information generated by a vehicle Global Positioning System (GPS) receiver that is connected to the two-way pager transceiver. The Jefferies et al. patent also discloses that subscription cost of the system can be reduced by using a pager identification channel access protocol code for a plurality of pagers that includes a local code indicating which individual pager should act on the message.

U.S. Pat. No. 6,901,253 to Bristow et al. also discloses a vehicle security and tracking system that a user can remotely activate. The vehicle tracking system includes a vehicle wireless transceiver communicating with a network operations center via a wireless communication network. The network operations center communicates with a user interface that permits a user to obtain status information about the vehicle. The security and tracking system uses mobile identification numbers (MINs) to send instructions between the network operations center and the vehicle wireless transceiver.

U.S. Pat. No. 5,276,728 to Pagliaroli et al. discloses a system for remotely activating a vehicle disabling system over a cellular communications network. The vehicle includes a receiver that receives a coded signal for disabling the vehicle via the cellular communications network. The coded signal may include the mobile telephone number of the receiver plus an additional vehicle control number.

The assignee of the present invention, Omega Patents, LLC, owns a group of patents directed to various significant improvements in vehicle tracking. Among these are U.S. Pat. Nos. 6,512,465; 6,522,267; 6,512,466; 6,509,868; 6,888,495; 6,507,786; 6,804,605; 6,606,561; 6,809,659; 6,798,356; 6,744,384; 6,765,499; 6,816,089; 6,741,187; 6,784,809; 6,798,355; 6,819,269; 6,844,827; 6,765,500; 6,628,196; 6,771,188; 6,803,861; 6,693,563; 6,703,946; and 6,737,989, the entire contents of each of which are incorporated herein by reference.

Unfortunately, the foregoing conventional systems typically will incur multiple charges when providing security and tracking for a fleet of vehicles.

### SUMMARY OF THE INVENTION

In view of the foregoing background, it is therefore an object of the invention to provide a vehicle tracker that is more economical and more efficient, especially for groups of vehicles.

This and other objects, features, and advantages in accordance with the invention are provided by a vehicle tracker that may include a cellular transceiver at a vehicle for receiving an activation message from a cellular communications network. The activation message may include a common telephone number for a plurality of vehicle trackers and a unique identification number for the vehicle tracker. A vehicle position-determining device may be at the vehicle. A controller at the vehicle may cooperate with the cellular transceiver and the vehicle position-determining device to transmit vehicle location data if the unique identification number in the received activation message matches the unique identification number for the vehicle tracker. Accordingly, a vehicle tracker is provided that has the economic advantage of a common telephone number for multiple vehicles.

The activation message may further comprise a common Mobile Identification Number (MIN) for the plurality of vehicle trackers. The vehicle tracker may further comprise a Subscriber Identity Module (SIM) card for storing the common telephone number. The SIM card may also store the unique identification number for the vehicle tracker. The position-determining device may comprise a Global Positioning System receiver, for example.

The vehicle tracker may further comprise at least one vehicle security sensor. The controller may cooperate with the vehicle security sensor to provide at least one vehicle security function. In addition, the controller may comprise a data bus interface for interfacing to a data communications bus that extends throughout the vehicle.

The vehicle tracker may be part of a vehicle tracking system in which a plurality of vehicles may have a respective vehicle tracker. Accordingly, the vehicle tracking system may include a user operable device to generate the activation message. The user operable device may comprise a computer device linked via the Internet to the cellular communications network, or may comprise a telephone device linked via the Public Switched Telephone Network (PSTN) to the cellular communications network, for example.

A method aspect of the invention is directed to using a vehicle tracker that may include a cellular transceiver, a vehicle position-determining device, and a controller connected to the cellular transceiver and vehicle position-determining device at a vehicle. The method may comprise sending an activation message to the cellular transceiver with the activation message comprising a common telephone number for a plurality of vehicle trackers and a unique identification number for the vehicle tracker. The method may further comprise using the cellular transceiver to receive the activation message. The method may yet further comprise using the controller to determine if the unique identification number in the received activation number matches the unique identification number for the vehicle tracker, and, if so, using the cellular transceiver to transmit vehicle location data determined by the vehicle position-determining device.

### BRIEF DESCRIPTION OF THE DRAWINGS

FIG. 1 is a schematic block diagram of the vehicle tracker and vehicle tracker system according to the invention.

FIG. 2 is a schematic block diagram of an alternative embodiment of the vehicle tracker and vehicle tracker system according to the invention.

FIG. 3 is a flowchart illustrating a method according to the invention.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

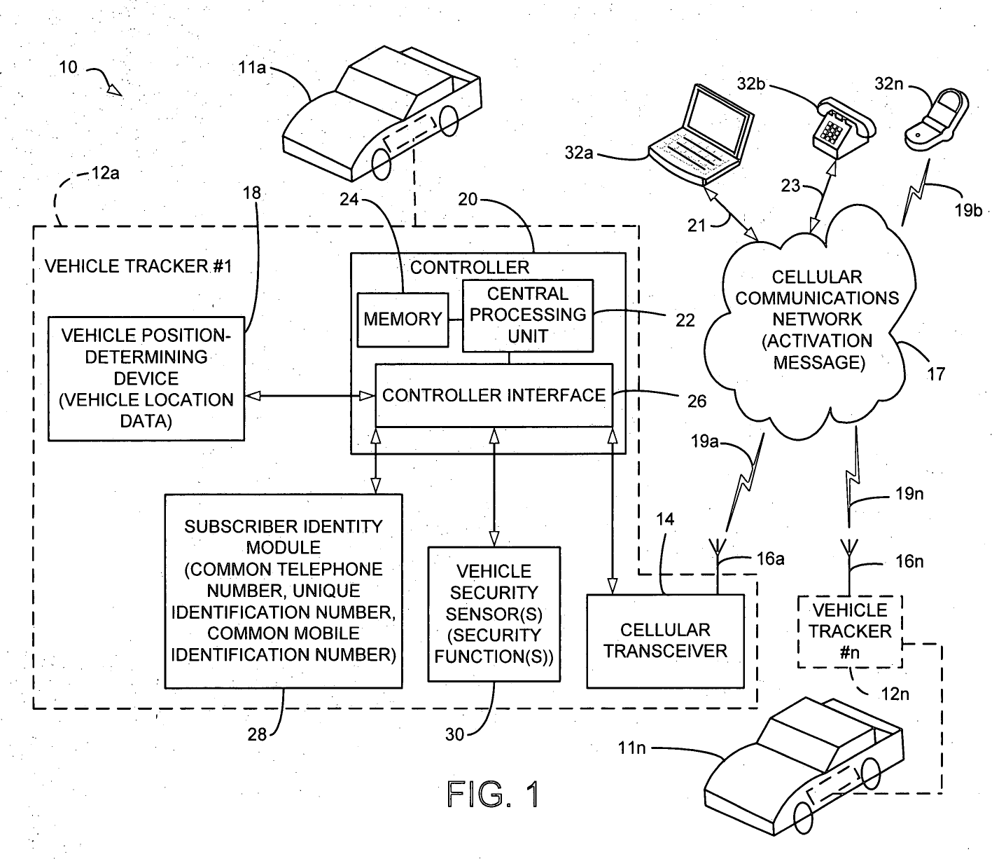

Referring initially to FIG. 1, a vehicle tracker system 10 for a plurality of vehicles 11a-11n each carrying a respective vehicle tracker 12a-12n in accordance with the invention is now described. The vehicle tracker 12a includes a cellular transceiver 14 connected to a cellular antenna 16a. The cellular transceiver 14 is at the vehicle 11a and receives an activation message from a cellular communications network 17 over a wireless cellular telephone communications link 19a as will be appreciated by those of skill in the art.

The activation message includes a common telephone number for a plurality of vehicle trackers 12a-12n and a unique identification number for the vehicle tracker 12a, for example. The activation message may further comprise a common Mobile Identification Number (MIN) for the plurality of vehicle trackers 12a-12n as will be appreciated by those of skill in the art. The activation message maybe transmitted to the cellular communications network 17 by a user operable device 32a-32n comprising a computer device 32a, a telephone device 32b, a cell phone 32n, and the like as shown in the illustrated embodiment. The user operable devices 32a-32n maybe linked to the cellular communications network 17 by an Internet connection 21, a Public Switched Telephone Network (PSTN) 23, a wireless communications link 19b, or the like as will be appreciated by those of skill in the art.

The vehicle tracker 12a further includes a vehicle position-determining device 18 and a controller 20 at the vehicle. The position-determining device 18 may comprise a Global Positioning System receiver, for example. The controller 20 includes a central processing unit 22 connected to a memory 24 and a controller interface 26 as will be appreciated by those of skill in the art.

The controller 20 cooperates with the cellular transceiver 14 and the vehicle position-determining device 18 to transmit vehicle location data if the received unique identification number in the received activation message matches the unique identification number for the vehicle tracker 12a, for example. Accordingly, the vehicle tracker 12a overcomes the limitations of conventional vehicle security and tracking systems by using the common telephone number.

The vehicle tracker 12a further illustratively includes a Subscriber Identity Module (SIM) card 28 to store the common telephone number, for example. The unique identification number for the vehicle tracker 12a maybe stored in the memory 24 and/or in the SIM card 28 as will be appreciated by those of skill in the art.

The vehicle tracker 12a further comprises at least one vehicle security sensor 30 such as a door pin switch, motion sensor, and the like. Accordingly, in some embodiments, the controller 20 may cooperate with the vehicle security sensor 30 to provide at least one vehicle security function as will be appreciated by those of skill in the art.

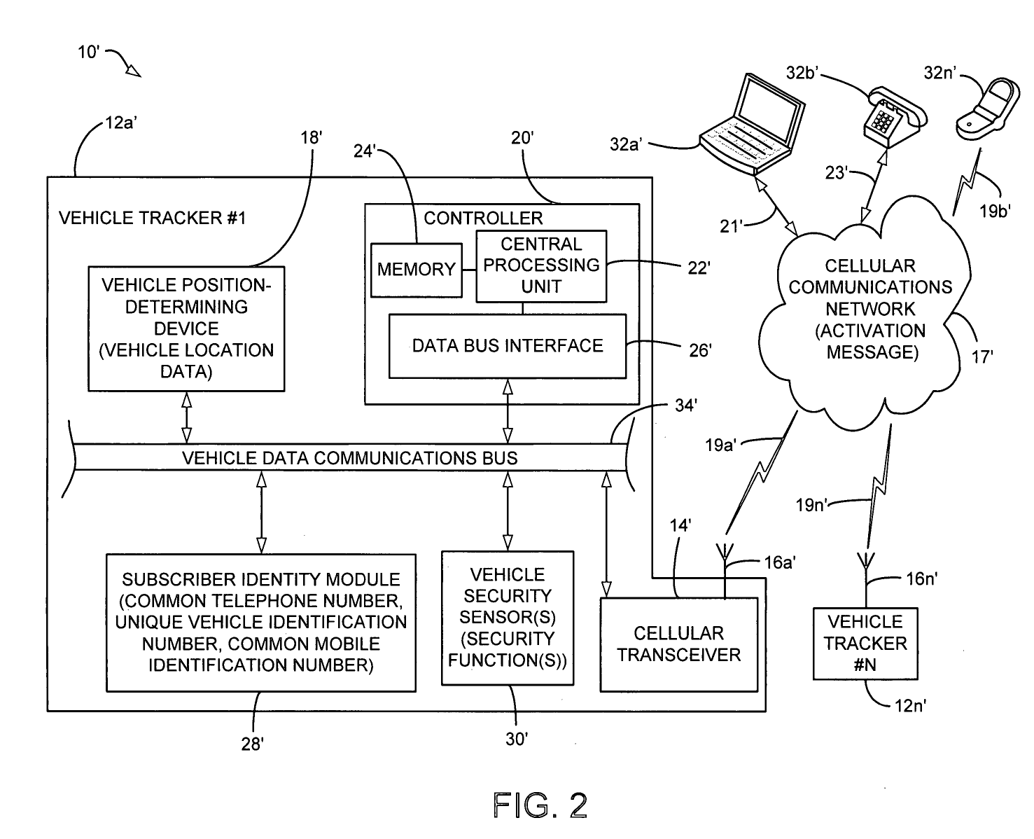

FIG. 2 illustrates an alternative embodiment of the vehicle tracker system 10′ and vehicle tracker 12a′. In this embodiment, the controller 20′ comprises a data bus interface 26′ for interfacing to a vehicle data communications bus 34′ extending throughout the vehicle as will be appreciated by those of skill in the art. Further details of interfacing to a data communications bus are disclosed in commonly assigned U.S. Pat. Nos. 5,719,551; 6,011,460; 6,243,004; 6,249,216; 6,696,927; 6,275,147; 6,812,829; 6,346,876; 6,756,885; 6,756,886; 6,480,098; 6,801,119; 6,297,731; 6,392,534; 6,771,167; and 6,529,124, the entire contents of each of which are incorporated herein by reference.

The vehicle tracker 12a may be part of a vehicle tracking system 10 in which a plurality of vehicles 11a-11n may carry a respective vehicle tracker 12a-12n, for example. The vehicle tracking system 10 includes a user operable device 32a-32n to generate the activation message as will be appreciated by those of skill in the art. The activation message generated by the user operable device 32a-32n is sent to the cellular communications network 17, which then transmits the activation message to the vehicle trackers 12a-12n as will be appreciated by those of skill in the art.

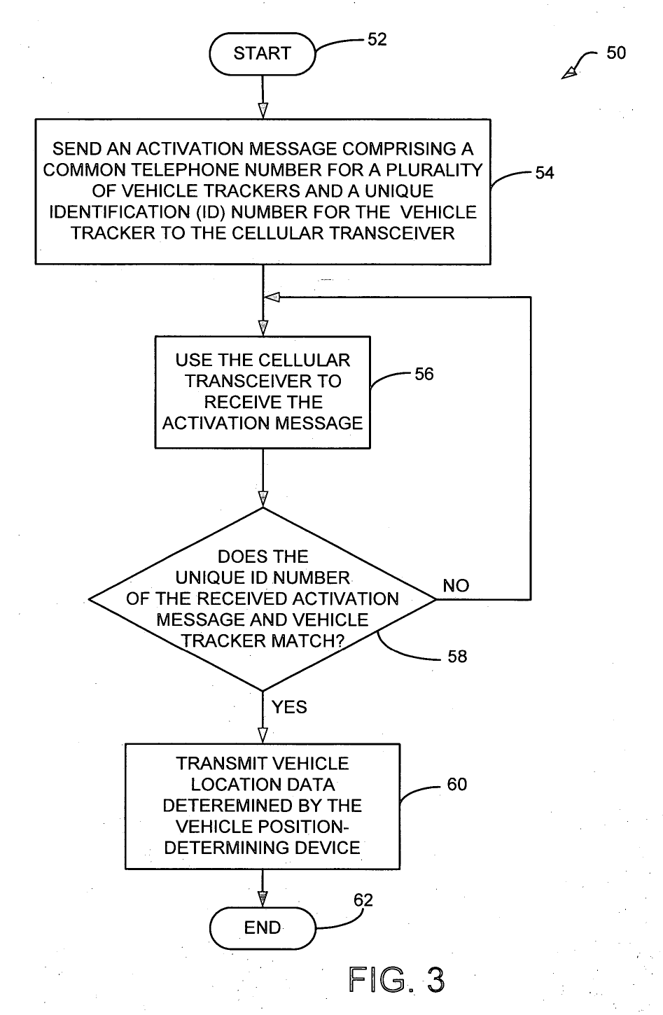

A method aspect of the invention is directed to using the vehicle tracker 12a and is now described with further reference to the flowchart 50 of FIG. 3. The vehicle tracker 12a includes a cellular transceiver 14, a vehicle position-determining device 18, and a controller 20 connected to the cellular transceiver and vehicle position-determining device at a vehicle 11a as described above.

The method starts at Block 52 and includes sending an activation message comprising a common telephone number for a plurality of vehicle trackers 12a-12n and a unique identification number for the vehicle tracker 12a to the cellular transceiver 14 at Block 54. The method further includes using the cellular transceiver 14 to receive the activation message at Block 56. The controller 20 then determines if the unique identification number in the received activation message matches the unique identification number for the vehicle tracker 12a at Block 58.

If the controller 20 determines the unique identification number of the activation message does not match the unique identification number of the vehicle tracker 12a, then the controller continues to monitor the cellular transceiver 14. If the controller 20 determines the unique identification number of the activation message does match the unique identification number of the vehicle tracker 12a, then the controller transmits, using the cellular transceiver 14, vehicle location data determined by the vehicle position-determining device 18 at Block 60. The method ends at Block 62.

As will be appreciated by those skilled in the art, the vehicle tracker 12a may also operate as a security system whereby if a breach of vehicle 11a security is detected, a call may be placed from the cellular transceiver 14 and typically to a central monitoring station. In conventional tracking systems using different MIN's for each vehicle tracker, at the central monitoring station the received unique MIN is matched to a user table and the user is then notified of the security breach. The user may also request or receive without further request, vehicle position information. In accordance with embodiments of the present invention using a common MIN for a plurality of vehicle trackers 12a-12n, the unique identification number for the vehicle tracker 12a may be also sent along with the common MIN so that the central station can determine the corresponding user to be notified.

Other advantageous features relating to vehicle tracking and/or vehicle security are disclosed in commonly assigned copending patent applications entitled “Vehicle Security System Receiving Acknowledgement of Transmitted Vehicle Security Message and Related Methods”, Ser. No. 11/144,866 filed Jun. 13, 2005; and “Vehicle Tracker Having Selectable Transceiver Mute Mode and Associated Methods”, Ser. No. 11/143,181, filed Jun. 2, 2005. The disclosure of each patent application is incorporated herein by reference in its entirety. As will be appreciated by those skilled in the art, the features disclosed in either or both of these applications may be used in conjunction with the features of the invention described herein.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A vehicle tracker comprising:
a cellular transceiver at a vehicle for receiving an activation message from a cellular communications network, the activation message comprising a common telephone number for a plurality of vehicle trackers and a unique identification number for the vehicle tracker;
a vehicle position-determining device at the vehicle; and
a controller at the vehicle cooperating with said cellular transceiver and said vehicle position-determining device for transmitting vehicle location data if the unique identification number in the received activation message matches the unique identification number for the vehicle tracker.

2. The vehicle tracker according to claim 1 wherein said activation message further comprises a common Mobile Identification Number (MIN) for the plurality of vehicle trackers.

3. The vehicle tracker according to claim 1 further comprising a Subscriber Identity Module (SIM) card for storing the common telephone number.

4. The vehicle tracker according to claim 3 wherein said SIM card further stores the unique identification number for the vehicle tracker.

5. The vehicle tracker according to claim 1 wherein said position-determining device comprises a Global Positioning System receiver.

6. The vehicle tracker according to claim 1 further comprising at least one vehicle security sensor; and wherein said controller cooperates with said at least one vehicle security sensor to provide at least one vehicle security function.

7. The vehicle tracker according to claim 1 wherein said controller comprises a data bus interface for interfacing to a data communications bus extending throughout the vehicle.

8. A vehicle tracker comprising:
a cellular transceiver at a vehicle for receiving an activation message from a cellular communications network, the activation message comprising a common telephone number for a plurality of vehicles and a unique identification number for the vehicle tracker;
a Global Positioning System (GPS) receiver at the vehicle;
a Subscriber Identity Module (SIM) card at the vehicle for storing the common telephone number; and
a controller at the vehicle cooperating with said cellular transceiver, said GPS receiver, and said SIM card for transmitting vehicle location data if the unique identification number in the received activation message matches the unique identification number for the vehicle tracker.

9. The vehicle tracker according to claim 8 wherein said activation message further comprises a common Mobile Identification Number (MIN) for the plurality of vehicle trackers; and wherein said SIM card further stores the common MIN for the vehicle tracker.

10. The vehicle tracker according to claim 8 wherein said SIM card further stores the unique identification number for the vehicle tracker.

11. The vehicle tracker according to claim 8 further comprising at least one vehicle security sensor; and wherein said controller cooperates with said at least one vehicle security sensor to provide at least one vehicle security function.

12. The vehicle tracker according to claim 8 wherein said controller comprises a data bus interface for interfacing to a data communications bus extending throughout the vehicle.

13. A vehicle tracking system for a plurality of vehicles comprising:
a respective vehicle tracker for each of the plurality of vehicles, each vehicle tracker comprising
a cellular transceiver for receiving an activation message from a cellular communications network, the activation message comprising a common telephone number for a plurality of vehicles and a unique identification number for the vehicle tracker,
a vehicle position-determining device, and
a controller cooperating with said cellular transceiver and said vehicle position-determining device for transmitting vehicle location data if the unique identification number in the received activation message matches the unique identification number for the vehicle tracker; and
a user operable device cooperating with the cellular communications network for generating the activation message.

14. The vehicle tracking system according to claim 13 wherein said user operable device comprises a computer device linked via the Internet to the cellular communications network.

15. The vehicle tracking system according to claim 13 wherein said user operable device comprises a telephone device linked via the Public Switched Telephone Network (PSTN) to the cellular communications network.

16. The vehicle tracking system according to claim 13 wherein said activation message further comprises a common Mobile Identification Number (MIN) for the plurality of vehicle trackers.

17. The vehicle tracking system according to claim 13 further comprising a Subscriber Identity Module (SIM) card for storing the common telephone number.

18. The vehicle tracking system according to claim 17 wherein said SIM card further stores the unique identification number for the vehicle tracker.

19. The vehicle tracking system according to claim 13 wherein said position-determining device comprises a Global Positioning System receiver.

20. The vehicle tracking system according to claim 13 wherein each vehicle tracker further comprises at least one vehicle security sensor; and wherein said controller cooperates with said at least one vehicle security sensor to provide at least one vehicle security function.

21. The vehicle tracking system according to claim 13 wherein said controller comprises a data bus interface for interfacing to a data communications bus extending throughout the vehicle.

22. A method for using a vehicle tracker comprising a cellular transceiver, a vehicle position-determining device, and a controller connected to the cellular transceiver and vehicle position-determining device at a vehicle, the method comprising:
sending an activation message to the cellular transceiver, the activation message comprising a common telephone number for a plurality of vehicle trackers and a unique identification number for the vehicle tracker;
using the cellular transceiver to receive the activation message; and
using the controller to determine if the unique identification number in the received activation number matches the unique identification number for the vehicle tracker, and, if so, using the cellular transceiver to transmit vehicle location data determined by the vehicle position-determining device.

23. The method according to claim 22 wherein sending the activation message comprises sending the activation message with a user operable computer device.

24. The method according to claim 22 wherein sending the activation message comprises sending the activation message with a user operable telephone device.

25. The method according to claim 22 wherein the activation message further comprises a common Mobile Identification Number (MIN) for the plurality of vehicle trackers.

26. The method according to claim 22 wherein the vehicle tracker further comprises at least one vehicle security sensor; and further comprising performing at least one vehicle security function using the controller and the at least one vehicle security sensor.

27. The method according to claim 22 wherein the vehicle comprises a data communications bus extending therethrough; and further comprising interfacing the controller to the data communications bus.
